(19) United States
(12) Patent Application Publication
(10) Pub. No.: US 2005/0248605 A1
(43) Pub. Date: Nov. 10, 2005

(54) Jet printer calibration

(76) Inventors: Adam I. Pinard, Carlisle, MA (US); Foster M. Fargo JR., Lincoln, MA (US)

Correspondence Address: Kristofer E. Elbing, 187 Pelham Island Road, Wayland, MA, 01778, US

(21) Appl. No.: 10/842,197

(22) Filed: May 10, 2004

(51) Int. Cl. B41J 29/393

(52) U.S. Cl. 347/19

(57) ABSTRACT

A jet printer is disclosed that features, in one general aspect, a plurality of detectors responsive to attributes of fluid drops emitted by a jet printing nozzle, and a statistical processing module responsive to an output of each of the detectors. Also disclosed is a printer with a first non-invasive printing fluid drop detector operative to detect printing fluid drops emitted by the jet printing nozzle during flight without significantly affecting their output trajectories, and an actuator operative to change an effective spatial relationship between the detector and the nozzle. Further disclosed is a printer with a first printing fluid drop detector operative to detect printing fluid drops emitted by a jet printing nozzle, and a first fluid drop impingement detection element operative to derive information about printing fluid drops emitted by the nozzle by interfering with their trajectories.

### FIELD OF THE INVENTION

This invention relates to the calibration of jet printers.

### BACKGROUND OF THE INVENTION

Inkjet printers have come into widespread use because they can print high quality color images at reasonably high speeds. Higher quality versions of such printers usually comprise a rotary drum for supporting a sheet of paper or other recording medium and a print head which is spaced from the drum surface and moved parallel to the drum axis. The movements of the drum and head are coordinated so that the head scans one or more rasters on the drum surface every rotation of the drum. The print head includes one or more ink nozzles (at least one per ink color), each of which can direct a jet of ink droplets to the paper on the drum. The jets are activated at selected positions in the scan to print an image on the paper composed of an array of ink dots.

Inkjet printing systems can be divided into drop-on-demand and continuous jet systems. In the former, the volume of a pressure chamber filled with ink is suddenly decreased by the impression of an electrical driving pulse whereby an ink droplet is jetted from a nozzle communicating with that chamber. Thus, a single drop of ink is transferred to the paper or other recording medium by a single driving pulse following which the system returns to its original state. During printing, a succession of such droplets is ejected as a jet in response to a succession of drive pulses to print an image on the paper according to a predetermined dot matrix. In the continuous jet-type system, a succession of ink drops is ejected from a jetter or nozzle. Selected ones of these drops are deflected electrostatically into a gutter, and the remaining undeflected drops reach the paper on the drum and form the printed image thereon according to a predetermined dot matrix. While the present invention is applicable to both jet printer types, the invention will be described primarily as it is applied to a continuous jet-type printer.

Inkjet printers are inherently capable of high-speed, high-resolution color printing. However, this requires precise manufacture and assembly of the component parts of the printer. Even then, the printer will not print with all colors in proper register unless the printer is calibrated so that the various nozzles on the print head are positioned properly relative to the drum and relative to each other. One prior art approach to printer calibration has employed a probe to detect the horizontal and vertical positions of the printer jets. Another proposed approach employs a pair of cameras to detect the horizontal and vertical positions of the printer jets.

### SUMMARY OF THE INVENTION

In one general aspect, the invention features a jet printer that includes a first non-invasive printing fluid drop detector operative to detect printing fluid drops emitted by a jet printing nozzle during flight without significantly affecting their output trajectories. An actuator is operative to change an effective spatial relationship between the first non-invasive printing fluid drop detector and the nozzle.

In preferred embodiments, the first non-invasive printing fluid drop detector can be a camera. The drop detector can be operative to detect streams of drops. The actuator can be operative to adjust a focal length of the camera. The printer can further include a statistical processing module responsive to images taken at different focal lengths. The actuator can be operative to move the detector. The actuator can be operative to rotate the detector. The actuator can be operative to translate the detector relative to the trajectories. The nozzle can be a continuous inkjet printing nozzle. The nozzle can be a drop-on-demand inkjet printing nozzle. The printer can further include drop trajectory error compensation logic responsive to the first non-invasive printing fluid drop detector. The drop trajectory error compensation logic can include a statistical processing module responsive to the first non-invasive printing fluid drop detector. The statistical processing module can include detector output weighting logic. The statistical processing module can include a Kalman filter. The first non-invasive printing fluid drop detector can be a camera, with the actuator being operative to adjust a focal length of the camera, and with the statistical processing module being operative to derive correction values based on images taken at different focal lengths. The drop trajectory error compensation logic can be operative to correct errors in any of three dimensions. The printer can further include a second non-invasive printing fluid drop detector operative to detect the printing fluid drops emitted by the jet printing nozzle without significantly affecting their output trajectories. The printer can further include drop trajectory error compensation logic that includes a statistical processing module responsive to the first and second non-invasive printing fluid drop detectors. The actuator can be operative to change an effective spatial relationship between the second non-invasive printing fluid drop detector and the nozzle at the same time that it changes an effective spatial relationship between the first non-invasive printing fluid drop detector and the nozzle.

In another general aspect, the invention features a jet printer that includes a jet printing nozzle, means for non-invasively detecting printing fluid drops emitted by the jet printing nozzle during flight without significantly affecting their output trajectories, and means for changing an effective spatial relationship between the means for non-invasively detecting fluid drops and the nozzle.

In a further general aspect, the invention features a jet printing method that includes non-invasively detecting at least one attribute of a printing fluid drop in a first trajectory with a first detector, changing an effective spatial relationship between the first detector and the first trajectory after the step of non-invasively detecting, and again non-invasively detecting the same attribute of another printing fluid drop in the first trajectory with the first detector after the step of changing.

In another general aspect, the invention features a jet printer that includes a jet printing nozzle, a plurality of detectors responsive to attributes of fluid drops emitted by the jet printing nozzle, and a statistical processing module responsive to an output of each of the plurality of detectors.

In preferred embodiments, the statistical module can include weighting logic to weight detector readings for the same nozzle differently. The statistical module can include a Kalman filter.

In a further general aspect, the invention features a jet printer that includes a jet printing nozzle, means for detecting a plurality of attributes of fluid drops emitted by the jet printing nozzle, and statistical processing means responsive to the means for detecting a plurality of attributes of fluid drops.

In another general aspect, the invention features a jet printing method that includes receiving a plurality of detector readings for a print drop trajectory, statistically processing the detector readings for the print drop trajectory, and compensating for errors in the trajectory based on results from the step of statistically processing.

In preferred embodiments, the step of statistically processing can weight the detector readings differently for the same trajectory. The step of receiving can receive redundant information. The step of processing can employ a Kalman filter. The step of compensating for errors can include steps of compensating for errors in three dimensions.

In a further general aspect, the invention features a jet printer that includes a first printing fluid drop detector operative to detect printing fluid drops emitted by the jet printing nozzle, and a first fluid drop impingement detection element operative to derive information about printing fluid drops emitted by the jet printing nozzle by interfering with their trajectories.

In preferred embodiments, the first printing fluid drop detector and the first impingement detection element can each include a plurality of edge portion pairs separated by different distances in a direction along a printer translation axis, and located at different distances along a test direction perpendicular to the translation direction. The first printing fluid drop detector and the first impingement detection element can both be N-shaped. The printer can further include a second fluid drop impingement detection element operative to derive information about printing fluid drops emitted by the jet printing nozzle by interfering with their trajectories. The first and second fluid drop impingment detection elements can each include a plurality of edge portion pairs separated by different distances in a direction along a printer translation axis, and located at different distances along a test direction perpendicular to the translation direction. The first and second fluid drop impingement detection elements can both be N-shaped. The first non-invasive printing fluid drop detector can be a camera. The first printing fluid drop detector can be a non-invasive printing fluid drop detective operative to detect printing fluid drops without significantly affecting their output trajectories. The first non-invasive printing fluid drop detector can be a camera. The printer can further include a strobed illumination source to allow detection of illumination drops. The first fluid drop impingement detection element can be within a field of view of the camera. The jet printing nozzle can be a continuous inkjet printing nozzle. The jet printing nozzle can be a drop-on-demand inkjet printing nozzle. The printer can further include drop trajectory error compensation logic responsive to the first printing fluid drop detector. The drop trajectory error compensation logic can include a statistical processing module responsive to the first printing fluid drop detector. The statistical processing module can include detector output weighting logic. The statistical processing module can include a Kalman filter. The drop trajectory error compensation logic can be operative to correct errors in any of three dimensions. The drop trajectory error compensation logic can include a statistical processing module responsive to the first printing fluid drop detector and to the first fluid drop impingement detection element. The statistical processing module can include detector output weighting logic. The statistical processing module can include a Kalman filter. The drop trajectory error compensation logic can be operative to correct errors in any of three dimensions. The first fluid drop impingement detection element can be an active impingement detector. The first printing fluid drop detector can be a direct detector operative to detect drops in flight.

In another general aspect, the invention features a jet printer that includes a jet printing nozzle, means for detecting printing fluid drops emitted by the jet printing nozzle, and means for deriving information about printing fluid drops emitted by the jet printing nozzle by interfering with their trajectories.

In a further general aspect, the invention features a jet printing method that includes receiving printing fluid drop detection readings for a print drop trajectory, receiving fluid drop impingement detection information for a print drop trajectory, and issuing printer calibration signals based on both the non-invasive printing fluid drop detection readings and the fluid drop impingement detection information.

Systems according to the invention may be particularly advantageous in that they allow for rapid, accurate, and robust calibration of an inkjet printer using relatively simple calibration hardware. This hardware needs only a single camera and may operate without any additional moving parts. As a result, printers can be equipped with calibration hardware for a relatively low cost and calibration of these systems can be performed frequently without undue delays.

The use of statistical techniques, such as Kalman filtering, also allows the printer to receive the maximum benefit from a given camera. This can allow a printer to be very precisely calibrated, resulting in improved print quality. The statistical technique's ability to extract information from a series of low quality images may also allow for the use of a much less expensive camera than might otherwise have been required. Statistical techniques can also derive information from two or more similar or different detectors to achieve more precise and/or accurate calibration.

### BRIEF DESCRIPTION OF THE DRAWINGS

FIG. 1 is a block diagram illustrating elements of a jet printer according to the invention;

FIG. 2 is a flowchart illustrating the operation of a Kalman filter for use with the jet printer of FIG. 1;

FIG. 3 is a block diagram illustrating a multi-detector calibration system usable in connection with the system of FIG. 1; and

FIG. 4 is a block diagram illustrating elements of a jet printer according to the invention that employs a triple-detector calibration system.

### DETAILED DESCRIPTION OF AN ILLUSTRATIVE EMBODIMENT

A jet printer 10 according to the invention includes a print substrate feed mechanism, a print head 14, a detector 16, and a jet calibration module 18. The feed mechanism can include a print drum 12 that supports a print substrate 20, although the invention is applicable to any of a variety of different feed mechanisms, such as platen- or web-based mechanisms. The print head can include one or more jet assemblies 22A, 22B, 22C . . . , 22N, which each include one or more nozzles that deposit ink on the substrate according to well-known ink-jet printing techniques. More information on these techniques is available in U.S. Pat. No. 6,626,527, filed on Oct. 12, 2000, and entitled INTERLEAVED PRINTING, which is herein incorporated by reference. The objectives of jet printer calibration are discussed in more detail in U.S. Pat. No. 5,160,938, entitled METHOD AND MEANS FOR CALIBRATING AN INK JET PRINTER, and in U.S. Published Application No. 20030189611, published Oct. 9, 2003, entitled JET PRINTER CALIBRATION, which are also both herein incorporated by reference.

The detector 16 can include an inexpensive CMOS-based integrating circuit equipped with a focusing lens, although other types of detectors could also be used. It can be mounted on an actuating mechanism, such as a lead-screw mechanism, that allows it to move with respect to the nozzles. In printers in which the print head is mounted on an actuated carriage, however, the carriage motion itself can provide relative motion between the nozzles and a fixed detector. It may also be possible to move an intermediate optical element to produce effective relative motion between the detector and nozzles, such as by moving a mirror or adjusting the focus of a lens assembly. And while calibration usually takes place to the side of the drum 12 during a dedicated calibration routine, it is possible for calibration to take place over the drum and/or during printing. The jet calibration module can be part of a separate hardware or software entity, or it can be incorporated into other parts of the printer, such as in the form of a program entity in a existing on-board processor.

In operation, relative motion is induced between the nozzles and the detector. As these two elements move with respect to each other, the detector acquires a series of readings. Where the detector is a camera, these readings are a series of two-dimensional images from different vantage points. The jet calibration module can then reconstruct the position of the nozzle along the axis of motion (x), and its distance from the detector (y).

Although straightforward trigonometric techniques can be employed in this reconstruction, it is preferable to use statistical techniques, such as Kalman filtering. Kalman filtering uses optimized recursive filters, called Kalman filters, which process available measurements, regardless of their precision, to estimate a current value for state variables of interest. Kalman filtering implementations employ a covariance matrix to express the reliability of current estimates. More information about Kalman filtering is available in, for example, Introduction to Random Signals and Applied Kalman Filtering, Third Edition, by Rober Grover Brown and Patrick Y. C. Hwang, John Wiley & Sons (1999), which is herein incorporated by reference.

The Kalman filter can be applied to x and y distances for some or all of the nozzles visible in each image. The position of the nozzles relative to the camera in different images will change, resulting in measurements in some images being less precise than those in others, but the Kalman filter is set up to weight the measurements in relation to their reliabilities. The overall results are therefore each in essence an aggregation of differently weighted measurements. Although it is possible, and perhaps tempting, to only rely on measurements in the image in which a nozzle of interest is optimally positioned relative to the camera, the aggregation of weighted information from the less precise measurements from other images will generally improve the accuracy of the overall result.

Although Kalman filtering is currently a preferred approach, other statistical methods may be adequate in certain circumstances. These methods can employ simplified filters that employ some, but not all, of the attributes of Kalman filtering, such as recursion, weighting of inputs, and the distillation of information from redundant sources. And other types of statistical methods that achieve comparable objectives in different ways are also applicable.

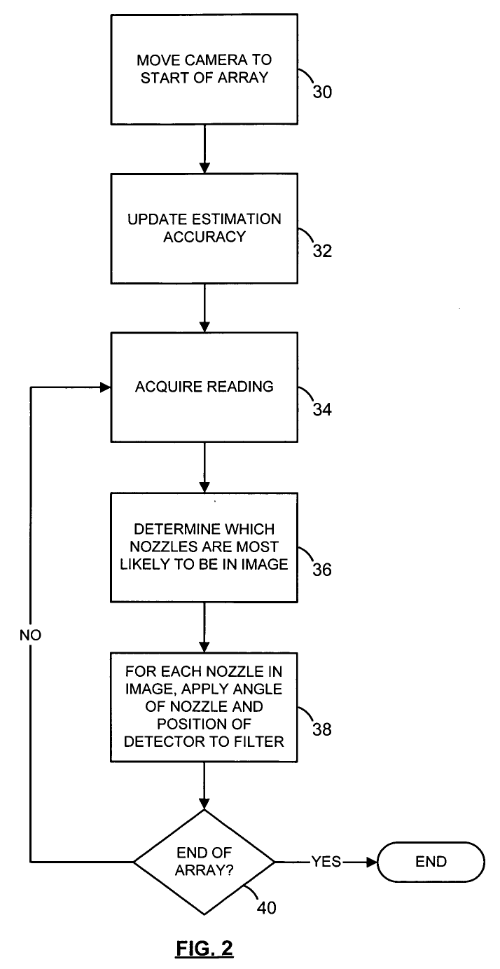

Referring to FIG. 2, calibration of the printer 10 will now be discussed in more detail. Calibration begins with the camera being moved to the start of the array (or vice-versa—step 30). The printer then updates its estimation accuracy (covariance matrix) for each jet based on the amount of time since the last scan (step 32). The detector can then acquire a reading (e.g., an image—step 34), and the calibration module 18 can determine which nozzles are most likely to be in the image (step 36). For each nozzle in the newly acquired image, the calibration module can apply the angle of the nozzle and the position of the detector to its Kalman filter (step 38). This process can be repeated until the end of the array is reached (step 40).

In one embodiment, the filter is an extended Kalman filter with 2 states: x position and y position. Each jet has its own 2×1 state and 2×2 covariance matrix. Initially, the x and y positions for each jet are set to the locations corresponding to the orifice plate, assuming they all point perfectly straight and the diagonal of the covariance is set to the RMS accuracy at the measurement point squared.

The input for each iteration of the filter is: present estimated jet position, covariance, camera position, and measured angle. The output is the new estimated jet position and covariance. The transition matrix is identity, so it is left out of the equations.

For one jet, the sequence can be expressed as:
EANGLE=a tan 2(JET(2)−CAMERA(2),JET(1)−CAMERA(1));
H=[−sin(EANGLE)\hat{ }2/(JET(2)−CAMERA(2)), cos(EANGLE)A2/(JET(1)−CAMERA(1))];
RES=EANGLE−ANGLE;
K=M*H′*(inv(H*M*H′+R));
P=(I−K*H)*M;
JET=JET−K*RES′;
P=P+QDT;
   Where:
H=1×2 Partial derivatives of angle with respect to Xpos and Ypos Equal to zero if not in picture.
CAMERA=2×1 Camera Xpos Ypos
JET=2×1 Jet Position Xpos, Ypos
EANGLE=1×1 Expected Angle between camera and jet
ANGLE=Actual measured angle between camera and jet
R=1×1 Measurement noise Variance in radians (Square of RMS)
RES=1×1 Residual error between what the expected and actual angle
K=2×2 Kalman Gain
P=Covariance Matrix
QDT=2×2 Additive drift variance. Diagonal is DriftBetweenPictures\hat{ }2 or DriftBetweenCalibrations\hat{ }2

The following sample MATLAB program illustrates the filter operation in more detail.

```
% Camera Image Reconstruction Program
% Finds X and Y position given multiple angular data
PICTURES=10;
CAMERATRAVEL=1000;
DT=1;
% Aim Drift Per Second at measured position in RMS microns
DRIFTRMS=.001;
% State matrix is:
% [Xpos Ypos]′
F=[0 0;
  0 0];
G=[DRIFTRMS 0;
  0 DRIFTRMS];
[PHI,QDT]=qpgn(F,G,DT);
% Initial RMS Position in microns
INITRMS=100;
P0 = [INITRMS\hat{ }2 0;
```

0 INITRMS\hat{ }2];

```
% Initial State
% [Xpos Ypos]′
XHAT=  [500; 10000];
INITPOS=XHAT+[randn(1)*INITRMS; randn(1)*INITRMS];
RMS_MEAS_NOISE=.0001;
R=RMS_MEAS_NOISE\hat{ }2;
% First Make up some data
ACTUALPOS=INITPOS;
for t=1:PICTURES
  CAMERA(1,t)=CAMERATRAVEL/PICTURES*(t−1);
  CAMERA(2,t)=0;
  [H,A]=get_angle(ACTUALPOS(:,t),CAMERA(:,t));
  ANGLE(t)=A+randn(1)*RMS_MEAS_NOISE;
  ACTUALPOS(:,t+1)= ACTUALPOS(:,t)+[randn(1)*DRIFTRMS;
randn(1)*DRIFTRMS];
end
% Kalman Loop
I=eye(2);
M=P0;
for t=1:PICTURES
  AXIS(t)=t*DT;
  % Get H matrix based upon estimated position and get estimated angle
  [H,A]=get_angle(XHAT,CAMERA(:,t));
  RES=A′-ANGLE(t)′;
  K=M*H′*(inv(H*M*H′+R));
  P=(I−K*H)*M;
  XHAT=XHAT−K*RES;
  % Store data for plots
  XHATTRACE(1,t)=XHAT(1);
  XHATTRACE(2,t)=XHAT(2);
  SIGXHATTRACE(1,t)=sqrt(P(1,1));
  SIGXHATTRACE(2,t)=sqrt(P(2,2));
  XHAT=PHI*XHAT;
  M=PHI*P*PHI′+QDT;
end
```

ERROR=ACTUALPOS(:,PICTURES)−XHAT
plot(AXIS,ACTUALPOS(1,1:PICTURES)−

XHATTRACE(1,:),AXIS,SIGXHATTRACE(1,:),
AXIS,−SIGXHATTRACE(1,:));

figure;
plot(AXIS,ACTUALPOS(2,1:PICTURES)−

XHATTRACE(2,:),AXIS,SIGXHATTRACE(2,:),
AXIS,−SIGXHATTRACE(2,:));

function [H,ANGLEHAT]=get_angle(XHAT,CAMERA)
% XHAT = Estimated state of system
% CAMERA = Camera Position
% H = Derivative Feedback Matrix
% H(1)= Change in angle with respect to
X_HAT(1) =−sin(angle)\hat{ }2/y =

y/hypotenuse

% H(2)= Change in angle with respect to
X_HAT(2) = cos(angle)\hat{ }2/x =

x/hypotenuse

% ANGLEHAT = Estimated angle of position
%Intializing ′H′:
H=zeros(1,2);
distx=XHAT(1)−CAMERA(1);
disty=XHAT(2)−CAMERA(2);
dist=(distx\hat{ }2+disty\hat{ }2)\hat{ }.5;
ANGLEHAT=atan2(disty,distx);
H(1)=−disty/dist\hat{ }2;
H(2)=+distx/dist\hat{ }2;

The calibration method described above can be modified in a variety of ways. Three-dimensional measurements could be performed instead of two-dimensional measurements. And although no focusing mechanism is required, an autofocusing system could be used on the camera, allowing the Kalman filter to include angle and distance to increase the accuracy over using angle alone. The camera could incorporate a rotation mechanism about the z-axis and make an additional pass could take place with the camera at a different angle (e.g., a instead of β). This would also allow for the angular calibration of the camera for more accurate results. Multiple cameras could also be used, but calibrating their angular sensitivity tends to be more difficult than in the case of a single rotating camera.

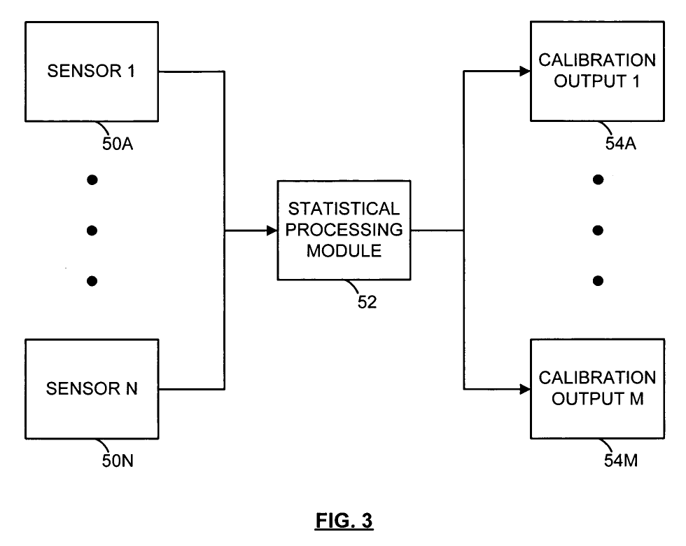

Referring to FIG. 3, it is also possible to combine the use of a first detector 50A, such as a camera, with one or more other detectors (e.g., 50N). These can also be cameras, or they can be detectors of one or more different types, such impingement probes. In this combined approach, the use of additional detectors can provide additional calibration information that can allow for additional types of measurements (e.g., 54M-x position, y position, and angular information) and/or more precise implementations of existing measurements (e.g., 54A) by providing additional inputs to a statistical processing module 52, such as a Kalman filter.

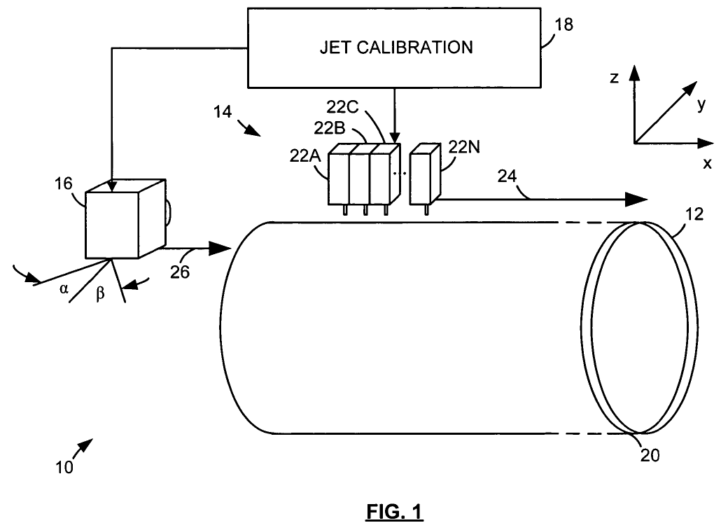

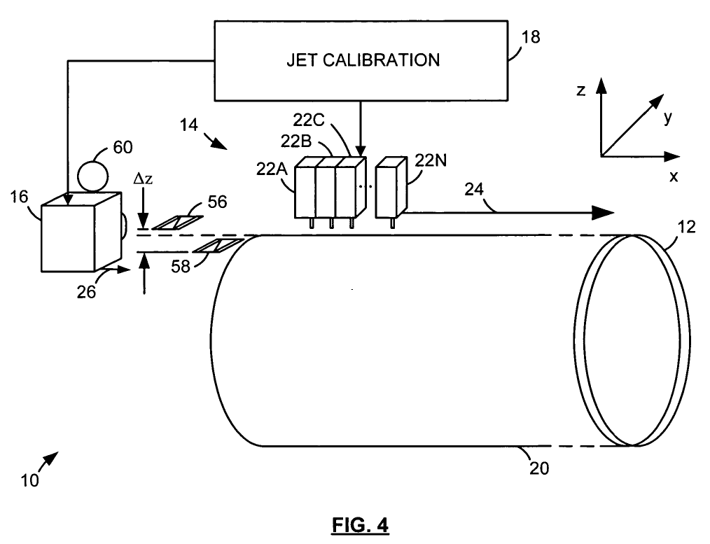

Referring to FIG. 4, in one example, an impingement probe, such as an N-shaped probe 56, is used to measure nozzle position and velocity, and a camera 16 is used to measure nozzle angle. In this example, the camera is mounted on a second rail and can travel in a direction 26 that is parallel to the direction of travel of the print carriage, as shown in FIG. 1, while the N-probe 56 is kept stationary with respect to the print media as described in the above-referenced published application entitled JET PRINTER CALIBRATION. It is also possible to add a second N-shaped probe 58 to this configuration to allow for depth (Az) measurements.

Cameras, probes, and/or other types of detectors can be combined in a variety of other ways to monitor a number of different calibration variables. The detectors can directly sense a variable, such as nozzle position, by detecting the position of a stream of drops. They can also sense the same variable indirectly, such as by making position measurements on drops after they have been deposited. Compound sensing arrangements can also be provided, such as by masking a flow of drops with a passive impingement element and then obtaining information about the drops that penetrate the mask with a second impingement detector or a non-invasive detector. Selection of a specific set of detectors and transfer function(s) for the drop trajectory error compensation logic will depend on a variety of printer design variables, including print speed, drop size, target calibration time, and/or detector parameters.

Embodiments employing a camera tend to operate more precisely if they are illuminated with a high-intensity strobed source 60, as discussed in Ink Jet Printing of Color Images, by Bo Samuelsson, Lund Institute of Technology, Lund, Sweden (1/1987), which is herein incorporated by reference. It can also be preferable to have some form of overlap between detector ranges. Locating an impingement detector within a field of view of a camera, for example, can provide an exact correspondence point between readings from the two detectors. This can reduce or eliminate errors due to inaccurate relative positioning of the detectors.

The present invention has now been described in connection with a number of specific embodiments thereof. However, numerous modifications which are contemplated as falling within the scope of the present invention should now be apparent to those skilled in the art. While the illustrative embodiment has deposited ink on a substrate supported by a drum, the invention is also applicable to other types of systems, such as platen-based printers, web-based printers, or plate setters. Therefore, it is intended that the scope of the present invention be limited only by the scope of the claims appended hereto. In addition, the order of presentation of the claims should not be construed to limit the scope of any particular term in the claims.

1. A jet printer, comprising:
a jet printing nozzle,
a first non-invasive printing fluid drop detector operative to detect printing fluid drops emitted by the jet printing nozzle during flight without significantly affecting their output trajectories, and
an actuator operative to change an effective spatial relationship between the first non-invasive printing fluid drop detector and the nozzle.

2. The jet printer of claim 1 wherein the first non-invasive printing fluid drop detector is a camera.

3. The jet printer of claim 1 wherein the drop detector is operative to detect streams of drops.

4. The jet printer of claim 2 wherein the actuator is operative to adjust a focal length of the camera.

5. The jet printer of claim 4 further including a statistical processing module responsive to images taken at different focal lengths.

6. The jet printer of claim 1 wherein the actuator is operative to move the detector.

7. The jet printer of claim 6 wherein the actuator is operative to rotate the detector.

8. The jet printer of claim 6 wherein the actuator is operative to translate the detector relative to the trajectories.

9. The jet printer of claim 1 wherein the jet printing nozzle is a continuous inkjet printing nozzle.

10. The jet printer of claim 1 wherein the jet printing nozzle is a drop-on-demand inkjet printing nozzle.

11. The jet printer of claim 1 further including drop trajectory error compensation logic responsive to the first non-invasive printing fluid drop detector.

12. The jet printer of claim 11 wherein the drop trajectory error compensation logic includes a statistical processing module responsive to the first non-invasive printing fluid drop detector.

13. The jet printer of claim 12 wherein the statistical processing module includes detector output weighting logic.

14. The jet printer of claim 12 wherein the statistical processing module includes a Kalman filter.

15. The jet printer of claim 12 wherein the first non-invasive printing fluid drop detector is a camera, wherein the actuator is operative to adjust a focal length of the camera, and wherein the statistical processing module is operative to derive correction values based on images taken at different focal lengths.

16. The jet printer of claim 11 wherein the drop trajectory error compensation logic is operative to correct errors in any of three dimensions.

17. The jet printer of claim 1 further including a second non-invasive printing fluid drop detector operative to detect the printing fluid drops emitted by the jet printing nozzle without significantly affecting their output trajectories.

18. The jet printer of claim 17 further including drop trajectory error compensation logic that includes a statistical processing module responsive to the first and second non-invasive printing fluid drop detectors.

19. The jet printer of claim 17 wherein the actuator is operative to change an effective spatial relationship between the second non-invasive printing fluid drop detector and the nozzle at the same time that it changes an effective spatial relationship between the first non-invasive printing fluid drop detector and the nozzle.

20. A jet printer, comprising:
a jet printing nozzle,
means for non-invasively detecting printing fluid drops emitted by the jet printing nozzle during flight without significantly affecting their output trajectories, and
means for changing an effective spatial relationship between the means for non-invasively detecting fluid drops and the nozzle.

21. A jet printing method, comprising:
non-invasively detecting at least one attribute of a printing fluid drop in a first trajectory with a first detector,
changing an effective spatial relationship between the first detector and the first trajectory after the step of non-invasively detecting, and
again non-invasively detecting the same attribute of another printing fluid drop in the first trajectory with the first detector after the step of changing.

22. A jet printer, comprising:
a jet printing nozzle,
a plurality of detectors responsive to attributes of fluid drops emitted by the jet printing nozzle, and
a statistical processing module responsive to an output of each of the plurality of detectors.

23. The jet printer of claim 22 wherein the statistical module includes weighting logic to weight detector readings for the same nozzle differently.

24. The jet printer of claim 22 wherein the statistical module includes a Kalman filter.

25. A jet printer, comprising:
a jet printing nozzle,
means for detecting a plurality of attributes of fluid drops emitted by the jet printing nozzle, and
statistical processing means responsive to the means for detecting a plurality of attributes of fluid drops.

26. A jet printing method, comprising:
receiving a plurality of detector readings for a print drop trajectory,
statistically processing the detector readings for the print drop trajectory, and
compensating for errors in the trajectory based on results from the step of statistically processing.

27. The method of claim 26 wherein the step of statistically processing weights the detector readings differently for the same trajectory.

28. The method of claim 26 wherein the step of receiving receives redundant information.

29. The method of claim 26 wherein the step of processing employs a Kalman filter.

30. The method of claim 26 wherein the step of compensating for errors includes steps of compensating for errors in three dimensions.

31. A jet printer, comprising:
a first printing fluid drop detector operative to detect printing fluid drops emitted by the jet printing nozzle, and
a first fluid drop impingement detection element operative to derive information about printing fluid drops emitted by the jet printing nozzle by interfering with their trajectories.

32. The jet printer of claim 31 wherein the first printing fluid drop detector and the first impingement detection element each include a plurality of edge portion pairs separated by different distances in a direction along a printer translation axis, and located at different distances along a test direction perpendicular to the translation direction.

33. The jet printer of claim 31 wherein the first printing fluid drop detector and the first impingement detection element are both N-shaped.

34. The jet printer of claim 31, further comprising a second fluid drop impingement detection element operative to derive information about printing fluid drops emitted by the jet printing nozzle by interfering with their trajectories.

35. The jet printer of claim 34 wherein the first and second fluid drop impingment detection elements each include a plurality of edge portion pairs separated by different distances in a direction along a printer translation axis, and located at different distances along a test direction perpendicular to the translation direction.

36. The jet printer of claim 34 wherein the first and second fluid drop impingement detection elements are both N-shaped.

37. The jet printer of claim 34 wherein the first non-invasive printing fluid drop detector is a camera.

38. The jet printer of claim 31 wherein the first printing fluid drop detector is a non-invasive printing fluid drop detective operative to detect printing fluid drops without significantly affecting their output trajectories.

39. The jet printer of claim 38 wherein the first non-invasive printing fluid drop detector is a camera.

40. The jet printer of claim 39 further including a strobed illumination source to allow detection of illumination drops.

41. The jet printer of claim 39 wherein the first fluid drop impingement detection element is within a field of view of the camera.

42. The jet printer of claim 31 wherein the jet printing nozzle is a continuous inkjet printing nozzle.

43. The jet printer of claim 31 wherein the jet printing nozzle is a drop-on-demand inkjet printing nozzle.

44. The jet printer of claim 31 further including drop trajectory error compensation logic responsive to the first printing fluid drop detector.

45. The jet printer of claim 44 wherein the drop trajectory error compensation logic includes a statistical processing module responsive to the first printing fluid drop detector.

46. The jet printer of claim 45 wherein the statistical processing module includes detector output weighting logic.

47. The jet printer of claim 45 wherein the statistical processing module includes a Kalman filter.

48. The jet printer of claim 44 wherein the drop trajectory error compensation logic is operative to correct errors in any of three dimensions.

49. The jet printer of claim 44 wherein the drop trajectory error compensation logic includes a statistical processing module responsive to the first printing fluid drop detector and to the first fluid drop impingement detection element.

50. The jet printer of claim 49 wherein the statistical processing module includes detector output weighting logic.

51. The jet printer of claim 49 wherein the statistical processing module includes a Kalman filter.

52. The jet printer of claim 49 wherein the drop trajectory error compensation logic is operative to correct errors in any of three dimensions.

53. The jet printer of claim 31 wherein the first fluid drop impingement detection element is an active impingement detector.

54. The jet printer of claim 31 wherein the first printing fluid drop detector is a direct detector operative to detect drops in flight.

55. A jet printer, comprising:
a jet printing nozzle,
means for detecting printing fluid drops emitted by the jet printing nozzle, and
means for deriving information about printing fluid drops emitted by the jet printing nozzle by interfering with their trajectories.

56. A jet printing method, comprising:
receiving printing fluid drop detection readings for a print drop trajectory,
receiving fluid drop impingement detection information for a print drop trajectory, and
issuing printer calibration signals based on both the non-invasive printing fluid drop detection readings and the fluid drop impingement detection information.
